(19) United States
(12) Patent Application Publication
(10) Pub. No.: US 2010/0157897 A1
(43) Pub. Date: Jun. 24, 2010

(54) MOBILE GATEWAY APPARATUS AND METHOD OF CONNECTING IP BASED SERVICES USING THE SAME

(75) Inventors: Sung-hyun YOON, Daejeon-si (KR); Soon-seok Lee, Daejeon-si (KR); Jong-dae Park, Daejeon-si (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/626,132

(22) Filed: Nov. 25, 2009

(30) Foreign Application Priority Data
Dec. 19, 2008 (KR) 10-2008-0130676

(51) Int. Cl. H04L 12/28; H04W 92/02

(52) U.S. Cl. 370/328; 370/401

(57) ABSTRACT

Disclosed are a mobile gateway apparatus and a method of connecting IP based services using the same. The mobile gateway apparatus assigns identifiers to user terminals that have accessed the mobile gateway apparatus through multiple internal interfaces based on various network access standards, and selects an appropriate external interface from multiple external interfaces based on various network access standards, thereby providing IP based services Even if the user terminals and the external networks operate based on various network access standards, the mobile gateway apparatus allows IP based services to be effectively provided to the user terminals by supporting more various network access standards while ensuring higher bandwidth.

### CROSS-REFERENCE TO RELATED APPLICATION

This application claims the benefit under 35 U.S.C. §119(a) of Korean Patent Application No. 10-2008-0130676, filed on Dec. 19, 2008, the disclosure of which is incorporated by reference in its entirety for all purposes.

### BACKGROUND

1. Field

The following description relates to a mobile gateway apparatus and a method of connecting IP based services using the same, and more particular, to a technology of easily providing IP based services to user terminals based on various network access standards.

2. Description of the Related Art

The wired IP environment has been rapidly developed together with the growth of an internet technology, but internet users desire mobile environment allowing the users to be free from wired environment. In this regard, various kinds of wireless network access technologies have developed satisfying such an increasing demand of the IP mobility. Further, the wireless network access technologies have been continuously developed to provide higher bandwidth and broader coverage.

The development of wireless network access technology is expected to continue to the extent that abundant IP based services currently available in wired IP environment, become available in wireless IP environment even in the case where a mobile user terminal is in motion. However, since the development on the wired IP technology is expected to be enhanced, the wireless network access technology requires great effort to reach the level of the wired environment.

Recently, various wireless access technologies including Zigbee, Bluetooth, UWB, WiFi, Wibro, WCDMA, etc. have been developed and applied to electronic products. Such wireless access technologies have different application coverage depending on their own characteristics. If all radio access technologies are implemented in a single user terminal, the user terminal can be available in all kinds of network system while supporting all kinds of wireless IP services. However, it will take very long time before such a perfect user terminal becomes feasible.

Even if the user terminal is realized, the user terminal would not be cost-effective and desirable in terms of mobility due to secondary effects such as interference and power loss.

For this reason, two or three kinds of radio access technologies for similar uses are usually implemented in a single user terminal. However, if multiple network interfaces are implemented in a user terminal, the cost of the user terminal is increased due to the addition of the multiple network interfaces and the additional use of network. Further, the user terminal having multiple interfaces requires greater power consumption as compared with a user terminal having a single network interface, and this accompanies an effort to solve secondary problems caused by the increased power consumption.

Accordingly, a study has been pursued on a technology capable of allowing a user to effectively use IP based services among user terminals and external networks with various network access standards and providing the user with seamless mobility by supporting more various network access standards while ensuring higher bandwidth.

### SUMMARY

Accordingly, in one aspect, there is provided a mobile gateway apparatus capable of allowing a user to effectively use IP based services among user terminals and external networks with various network access standards and providing the user with seamless mobility by supporting more various network access standards while ensuring higher bandwidth and a method of connecting IP based services using the same.

In another aspect, there is provided a mobile gateway apparatus capable of guaranteeing seamless mobility when providing user terminals based on various network access standards with IP based services and a method of providing IP based services using the same.

In still another aspect, there is provided a mobile gateway apparatus and a method of providing IP based services using the same, wherein, when a user terminal migrates into a new mobile gateway apparatus, IP based services are taken over through the new mobile gateway apparatus such that the user terminal can use the IP based services.

In one general aspect, there is provided a mobile gateway apparatus. The mobile gateway apparatus assigns identifiers to user terminals that have accessed the mobile gateway apparatus through multiple internal interfaces based on various network access standards and selects at least one appropriate external interface from multiple external interfaces based on various network access standards such that an IP based service is provided.

The mobility gateway apparatus guarantees seamless IP mobility by selecting an external interface having a most suitable connection status at a predetermined time from the multiple external interfaces connected to the external networks to establish an IP communication channel through the selected external interface.

If the user terminal migrates into a communication area of another mobile gateway apparatus, information for succession of IP based service is transmitted to the another mobile gateway apparatus.

In another general aspect, there is provided a method of connecting IP based services through a mobile gateway apparatus. The method is performed as follows. A communication channel for the IP based services is established by selecting an external interface having a suitable connection status from multiple external interfaces. When a user terminal enters a communication area of the mobile gateway apparatus, the mobile gateway apparatus authorizes the user terminal to use the mobile gateway apparatus. If the user terminal is authorized to use the mobile gateway apparatus, the mobile gateway apparatus allocates an IP address to the authorized user terminal such that the user terminal uses the IP based service.

Even if the user terminals and the external networks operate based on various network access standards, the mobile gateway apparatus allows IP based services to be effectively provided to the user terminals by supporting more various network access standards while ensuring higher bandwidth. In addition, in the mobile gateway apparatus and the method of connecting IP based services using the same, various network access standards having different characteristics, for example, the range, speed and bandwidth, are complementary to each other, so that a wider application coverage of the mobile gateway apparatus is realized.

The mobile gateway apparatus can guarantee seamless mobility when providing the IP based services to the user terminals based on various network access standards.

In addition, when a user terminal migrates into an area of a new mobile gateway apparatus, IP based services are taken over from the new mobile gateway apparatus and thus the user terminal can use the IP based services, and unnecessary processes such as authorization and address allocation can be omitted. Accordingly, the user terminal can obtain improved mobility and load applied to the mobile gate apparatus can be reduced.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram illustrating an exemplary mobile gateway apparatus;

FIG. 2 is a block diagram illustrating an exemplary controller of the mobile gateway apparatus shown in FIG. 1;

FIG. 3 is a view illustrating a communication area of the exemplary mobile gateway apparatus that is changed as a user terminal migrates; and

FIG. 4 is a flowchart illustrating an exemplary method of connecting IP based services through a mobile gateway apparatus.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

In the following description, a detailed description of known functions and configurations incorporated herein will be omitted when it may obscure the subject matter with unnecessary detail.

Before describing the exemplary embodiments, terms used throughout this specification are defined. These terms are defined in consideration of functions according to exemplary embodiments, and can be varied with an intention of a user or manager, or a relevant standard and so on. Therefore, definitions of the terms should be made on the basis of the overall context.

A user terminal described throughout the specification refers to a terminal which has been generally used by users to date or is currently in general use, enabling a communication through a network interface. A user terminal is classified into a user terminal supporting IP communication standards and a user terminal not supporting IP communication standards.

A user terminal supporting IP communication standards refers to a user terminal such as personal computers (PC), personal digital assistants (PDA), laptop computers and mobile phones on which an internet protocol stack is mounted and thus allows a user to use IP based services through a network interface.

A user terminal which does not support IP communication standards refers to a user terminal which has a network interface but does not have an internet protocol stack.

A mobile gateway described throughout the specification is an individual apparatus which is provided among user terminals based on various network access standards and external networks based on various network access standards and offers IP based services to the user terminals.

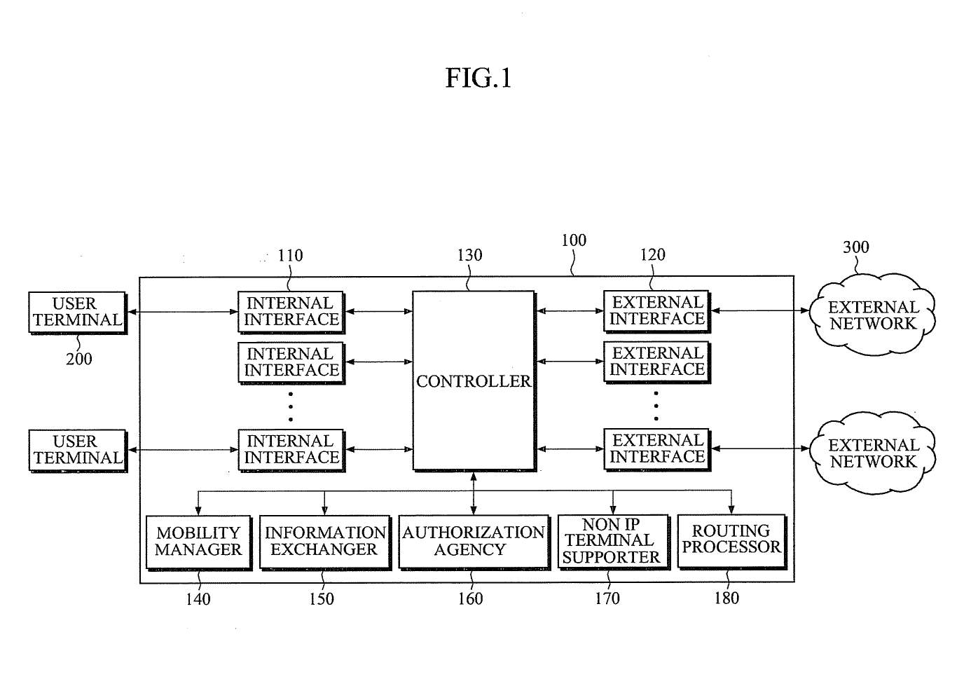

FIG. 1 is a block diagram illustrating an exemplary mobile gateway apparatus. As shown in FIG. 1, a mobile gateway apparatus 100 includes multiple internal interfaces 110, multiple external interfaces 120 and a controller 130.

The multiple internal interfaces 110 are used to support access of various kinds of user terminals 200 such as PCs, PDAs, laptop computers and mobile phones, and operate based on various network access standards.

Each of the multiple internal interfaces 110 provides access of various user terminals 200 entering into an area of the mobile gateway apparatus 100. The internal interfaces 110 are determined depending on a processing capacity of the mobile gateway apparatus 100 and an internal network access technology supported by the mobile gateway apparatus 100. For this reason, the internal interfaces 110 are implemented as a modular unit such that a network access function is selectively removed or implemented on the mobile gateway apparatus 100.

The multiple external interfaces 120 are used to provide an access to external networks 300 such as a Wibro network, a CDMA network and a WiFi network. The multiple external interfaces 120 may have various network access standards. The external interface 120 is selected depending on a processing capacity of the mobile gateway apparatus 100 and an external network access technology supported by the mobile gateway apparatus 100. For this reason, the external interface 120 is implemented into a modular unit such that a network access function is selectively moved or implemented on the mobile gateway apparatus 100.

The multiple external interfaces 120 respectively manage an access to corresponding network areas, thereby guaranteeing mobility of the mobile gateway apparatus 100. In this regard, the external interface 120 is implemented by employing interfaces except for a wired network interface having a limited mobility and a narrow band wireless network.

Since wireless access technologies such as WiFi, Wibro, WCDMA, and other radio access technologies that come to light in the future have different application coverage depending on technological characteristics thereof, the wireless access technologies implemented are complementary to each other in a single equipment. In this regard, in order to guarantee mobility of the mobile gateway apparatus 100, mutually exclusive coverage and characteristic need to be implemented in a mobile gateway apparatus such that the mobility of the mobile gateway apparatus is guaranteed.

The controller 130 assigns identifiers to the user terminals 200 which have accessed the mobile gateway apparatus 100 through the multiple internal interfaces 110 and selects at least one appropriate external interface from the multiple external interfaces, thereby providing IP based services to the user terminals 200.

In this manner, even if the user terminals 200 and the external networks 300 operate based on various network access standards, the mobile gateway apparatus 100 can effectively provide the user terminals 200 with the IP based services by supporting more various network access standards while ensuring higher bandwidth.

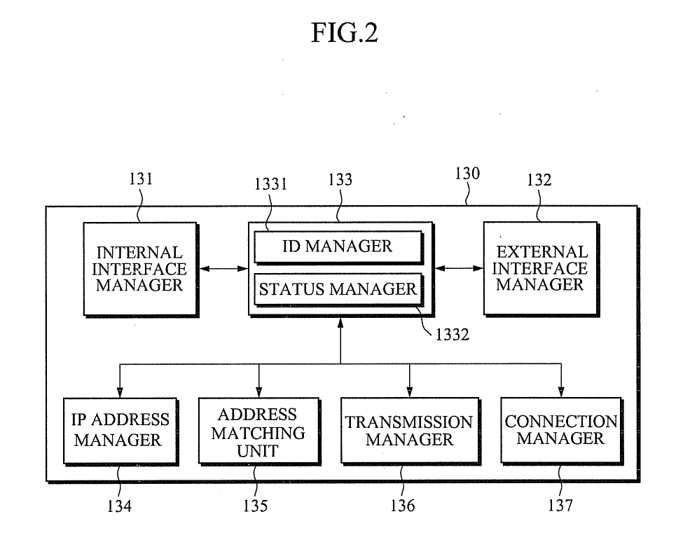

Hereinafter, the controller 130 will be described with reference to FIG. 2. The controller 130 has a configuration capable of providing various kinds of user terminals 200 with the IP based services. FIG. 2 is a block diagram illustrating an exemplary controller of the mobile gateway apparatus shown in FIG. 1.

As shown in FIG. 2, the controller 130 includes an internal interface manager 131, an external interface manager 132, a user terminal manager 133, an IP address manager 134, an address matching unit 135 and a transmission manager 136.

The internal interface manager 131 manages the multiple internal interfaces 110. That is, the internal interface manager 131 manages the multiple internal interfaces 110 that operate based on various network access standards and supporting an access of various user terminals 200 such as PCs, PDAs, laptop computers, and mobile phones.

The external interface manager 132 manages the multiple external interfaces 120. That is, the external interface manager 132 manages the multiple external interfaces 120 that operate based on various network access standards and are used for the access to various external networks 300 such as Wibro networks, CDMA networks and Wifi networks.

The user terminal manager 133 assigns an identifier to the user terminal 200 that has accessed through one of the multiple internal interfaces 110 managed by the internal interface manager 131, and manages the user terminal 200 identified by the identifier.

The user terminal manager 133 includes an ID manager 1331 and a status manager 1332. The ID manager 1331 assigns the identifier to the user terminal 100 which has accessed to the mobile gateway apparatus 100 and controls mobility of the user terminal 100 based on the identifier. The status manager 1332 controls a quality of service (QoS) by managing status information including signal intensity and a connection status that are acquired from the connected user terminal 200.

Meanwhile, the user terminal manager 133 assigns the identifier to the user terminal 200 by use of an identifier of the internal interface, to which the user terminal 200 is connected, and an access sequence of the user terminal 200. For example, if the internal interface 100 to which the user terminal 200 is connected has an identifier of A000 and the user terminal 200 has an access sequence of 0031, the user terminal manger 133 assigns an identifier of A0000031 to the user terminal 200.

Since the ID information managed by the ID manager 1331 and the status information managed by the status manager 1332 are expected to frequently change, the ID information and the status information are provided in the form of a table, and stored and managed in a memory of the mobile gateway apparatus 100.

The IP address manager 134 allocates IP addresses to the mobile gateway apparatus 100 and the user terminals 200 managed by the user terminal manager 133, and manages the IP addresses.

Each of the mobile gateway apparatus 100 and the user terminals 200 accessing the mobile gateway apparatus 100 requires an IP address to use IP based services.

The mobile gateway apparatus 100 allocates public IP addresses, which are used for a connection to the internet, to the multiple external interfaces 120, respectively, through the IP address manager 134.

If the external interface 120 fails to acquire such a public address by itself, the external interface 120 needs to acquire the public IP address through a Dynamic Host Configuration Protocol (DHCP). Otherwise, the public IP address is manually specified in the external interface 120.

Meanwhile, the mobile gateway apparatus 100 allows the IP address manager 134 to allocate an IP address to a user terminal that has accessed the internal interface 120 to use the IP based service but has failed to acquire an IP address by itself.

For example, the IP address manager 134 dynamically allocates a public IP address to a user terminal, which has accessed the mobile gateway apparatus 100 through the internal interface 110 but has failed to acquire an IP address by itself, through a dynamic host configuration protocol (DHCP).

Alternatively, the IP address manager 134 may allocate a private IP address to a user terminal 200, which has accessed the mobile gateway apparatus 100 through the internal interface 110 but has failed to acquire an IP address by itself, through a network address port translation (NAPT). In communication with the external networks, the private IP address may be changed into a public address by the mobile gateway apparatus 100.

The address matching unit 135 defines a relationship between the identifier assigned to the user terminal 200 by the user terminal manager 133 and the IP address allocated to the user terminal 200 by the IP address manager 134, and matches the identifier with the IP address.

The mobile gateway apparatus 100 manages the user terminal 200 based on the identifier assigned to the user terminal 200. Meanwhile, the IP address allocated to the user terminals 200 may be changed, as the user terminal 200 migrates. Accordingly, in order to establish an effective communication channel for the user terminal 200, the identifier assigned to the user terminal 200 needs to be matched with an IP address, which has been newly allocated to the user terminal 200, through the address matching unit 135.

The transmission manager 136 connects the internal interface 110, to which the user terminal 120 is connected, with the external interface 120, to which the internal interface 110 is connected such that the IP based services are connected between the user terminal 200 and the external network 300.

The mobile gateway apparatus 100 needs to serve as a relay between the user terminal 200 and the external network 300 to effectively provide the IP based service to the user terminal 200. In detail, the transmission manager 136 connects a communication channel of the user terminal 200, which is connected to the internal interface 110, to the external interface 120 connected to the external network 300. As described above, the mobile gateway apparatus 100 assigns the identifier to the user terminal 200, allocates the IP address to the user terminal 200 access IP based services, manages a connection between the mobile gateway apparatus 100 and the user terminal 200 by matching the identifier with the IP address, and establishes a communication channel between the user terminal 200 and the external network 300, so that a connection of IP based services is managed.

In this regard, even if the user terminals and the external networks operate based on various network access standards, since the mobile gateway apparatus 100 can support more various kinds of network access standards and ensure higher bandwidth, the IP based services can be effectively provided to the user terminals 200.

Meanwhile, according to another aspect, the controller 130 further includes a connection manager 137. The connection manager 137 manages a connection setup between the mobile gateway apparatus 100 and the user terminal 200 based on information managed by the user terminal 200 such that an access point of the user terminal 200 is prevented from frequently changing.

The mobile gateway apparatus 100 allows the user terminals 200 to be connected to the internal interfaces 110, respectively. An access point connected to the user terminal 200 may be changed depending on the signal intensity of the mobile gateway apparatus 100.

However, the frequency change of the access point increases load applied to the user terminal 200 and the mobile gateway apparatus 100, and this thus degrades the quality of IP based services. That is, the user terminal 200 using the IP based service through the mobile gateway apparatus 100 is desired to maintain a connection with the current mobile gateway apparatus except when the current mobile gateway apparatus 100 is not available.

The mobile gateway apparatus 100 manages a connection setup with respect to the user terminal 200 based on the information managed by the user terminal 200 to prevent an access point connected to the user terminal 200 from frequently changing, thereby improving the quality of IP based services.

Meanwhile, according to another aspect, the mobile gateway apparatus 100 may further include a mobility manager 140. The mobility manager 140 is configured to guarantee mobility of the mobile gateway apparatus 100.

The mobility manager 140 guarantee seamless mobility by selecting an external interface having the most suitable connection status at a predetermined time among the multiple external interfaces 120 connected to the external networks 300 to establish an IP communication channel through the selected external interface.

Accordingly, the mobile gateway apparatus 100 guarantees seamless mobility through the mobility manager 140, and thus the user terminals based on various network access standards can use seamless IP based service.

Meanwhile, according to another aspect, the mobile gateway apparatus 100 may further include an information exchanger 150. The information exchanger 150 is constituted to exchange information between the mobile gateway apparatus 100 and another mobile gateway apparatus.

As the user terminal 200 migrates into a communication area of the another mobile gateway apparatus, the information exchanger 150 transmits information used for succession of the IP based services to the another mobile gateway apparatus.

Meanwhile, the information used for succession of the IP based services includes ID information managed by the user terminal manager 133 and IP address allocation information managed by the IP address manager 134.

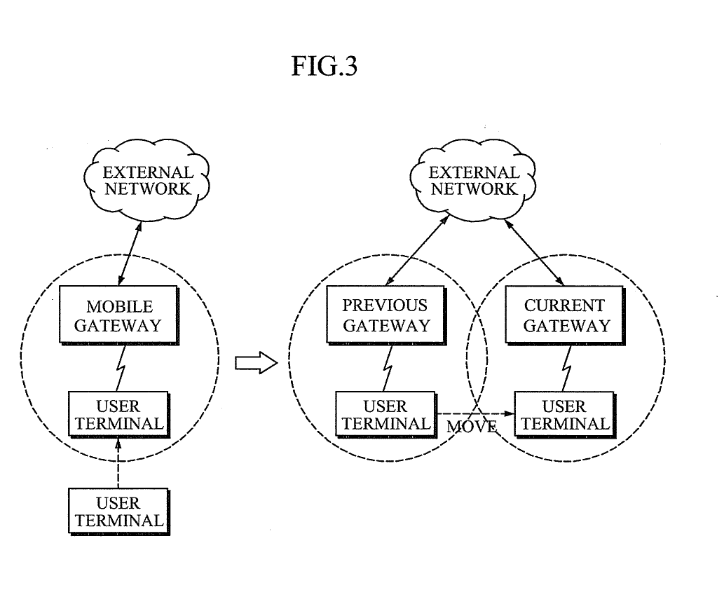

That is, according to the present embodiment, as shown in FIG. 3, as the user terminal migrates from a communication area of a previous mobile gateway apparatus to a communication area of a new mobile gateway apparatus, information used for succession of IP based service is transmitted through the information exchanger 150, and thus a handover between mobile gateway apparatuses is achieved.

For example, such a succession of IP based service between the mobile gateway apparatuses allows unnecessary processes, such as authorization and address allocation, to be omitted, thereby providing the user terminal with improved mobility and reducing the load applied to the mobile gate apparatus.

Meanwhile, according to another aspect, the mobile gateway apparatus 100 may further include an authorization agent 160. The authorization agent 160 authorizes the user terminal 200 to use a service provided by the mobile gateway apparatus 100.

In order for each of the user terminals 200 to use the IP based service provided through the mobile gateway apparatus 100, the user terminal 200 needs to subscribe a service giving permission to use the mobile gateway apparatus 100. To this end, a predetermined authorization process for the subscription needs to be prepared. The mobile gateway apparatus 100 authorizes the user terminal 200 to use the mobile gateway apparatus 100 through the authorization agent 160. For example, the authorization for the user terminal 200 may be implemented using the authentication & authorization & accounting (AAA) function.

Meanwhile, according to another aspect, the mobile gateway apparatus 100 may further include a non-IP terminal supporter to support access of a non-IP user terminal 200 which does not support an IP communication standard.

A user terminal, which has a network interface but does not have an internet protocol stack, is connected to the mobile gateway apparatus 100 through the internal interface 110, and is allocated an ID through the controller 130.

In this case, the non-IP terminal supporter 170 allows the non-IP user terminal 200 to use the IP address allocated to the mobile gateway apparatus 100 as an IP address for IP based service. In addition, the non-IP terminal distinctively maintains a communication channel between the mobile gateway apparatus 100 and the non-IP user terminal 200 on a lower layer interface than an IP layer by user of an identifier allocated to the non-IP user terminal 200. Accordingly, the IP based service can be provided to the user terminal 200 which has a network interface and does not have an internet protocol stack.

Meanwhile, according to another aspect, the mobile gateway apparatus 100 may further include a routing processor 180. The routing processor 180 supports a routing function and an adhoc function in a manner that the mobile gateway apparatus 100 is connected to another mobile gateway apparatus through the external interface 120 and the mobile gateway apparatus 100 serves as a relay node for routing packets.

When an external network connected to the mobile gateway apparatus 100 through the external interface 120 does not exist or if, in order to guarantee mobility it is deemed necessary, the mobile gateway apparatus 100 may be connected to another mobile gateway apparatus through the external interface, thereby guaranteeing mobility.

For example, a first mobile gateway apparatus connected to a Wibro network through an external interface and a second mobile gateway apparatus connected to a CDMA network are connected to an external interface for supporting a Wifi network, thereby establishing a communication service.

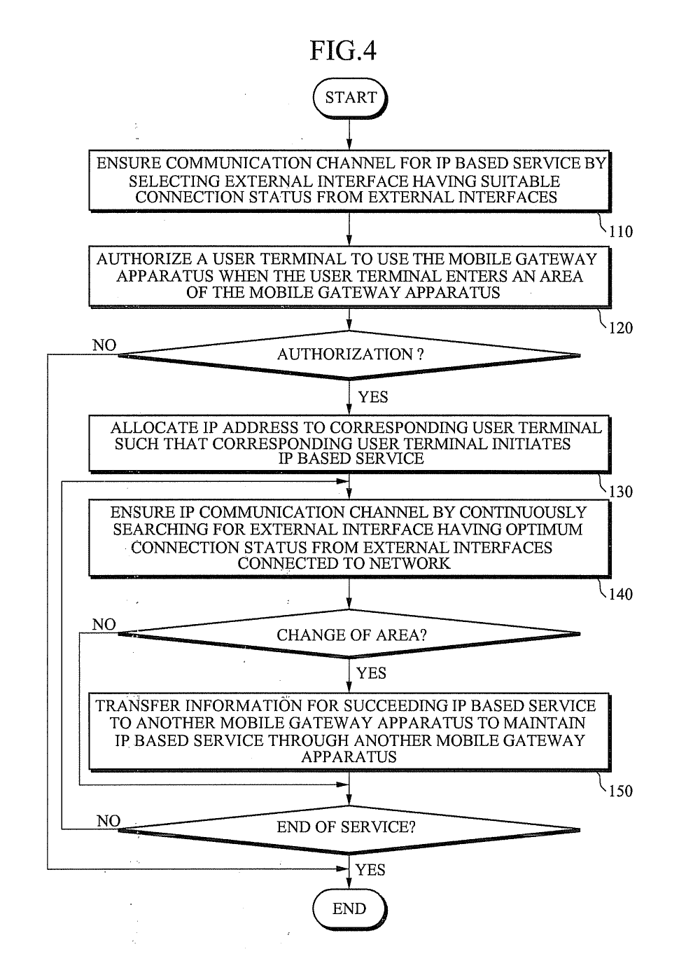

Hereinafter, an IP based service connection over the mobile gateway apparatus will be described with reference to FIG. 4. FIG. 4 is a flowchart illustrating an exemplary method of providing IP based services through a mobile gateway apparatus.

First, a communication channel for IP based services is established by selecting an external interface having a suitable connection status from multiple external interfaces (operation 110).

After that, when a user terminal enters a communication area of the mobile gateway apparatus, the mobile gateway apparatus authorizes the user terminal to use the mobile gateway apparatus (operation 120).

If the user terminal is authorized to use the mobile gateway apparatus, the mobile gateway apparatus allocates an IP address to the authorized user terminal such that the user terminal uses the IP based services (operation 130).

Accordingly, even if the user terminals and the external networks operate based on various network access standards, the mobile gateway apparatus can effectively provide the user terminals with the IP based services by supporting more various network access standards while ensuring higher bandwidth.

Meanwhile, according to another aspect, the mobile gateway apparatus continuously searches for an external interface having the most suitable connection status from the multiple external interfaces connected to networks to establish an IP communication channel, so that seamless IP mobility is ensured (operation 140).

Accordingly, the mobile gateway apparatus can guarantee seamless mobility when providing the IP based services to user terminals based on various network access standards.

Meanwhile, according to another aspect, if the user terminal migrates into a communication area of another mobile gateway apparatus during the providing of the IP service, information for succession of the IP based services is transmitted to the another mobile gateway apparatus, so that IP based services can be maintained through the mobile gateway apparatus transmits (operation 150).

In this mariner, the user terminal does not need to be subject to unnecessary processes, such as authorization and address allocation, so the user terminal can obtain improved mobility and the load applied to the mobile gate apparatus due to the unnecessary processes can be reduced.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. A mobile gateway apparatus comprising:
multiple internal interfaces based on various network access standards to support access of various kinds of user terminals;
multiple external interfaces based on various network access standards to access various kinds of external networks; and
a controller to respectively assign identifiers to user terminals that have accessed the mobile gateway apparatus through the multiple internal interfaces and to select at least one appropriate external interface from the multiple external interfaces such that an IP based service is provided.

2. The mobile gateway apparatus of claim 1, wherein the controller comprises:
an internal interface manager to manage the multiple internal interfaces;
an external interface manager to manage the multiple external interfaces;
a user terminal manager to respectively assign the identifiers to the user terminal that have accessed through the multiple internal interfaces managed by the internal interface manager, and to manage the user terminals identified by the identifiers;
an IP address manager to respectively allocate IP addresses to the mobile gateway apparatus and the user terminals managed by the user terminal manager and to manage the allocated IP addresses;
an address matching unit to define a relationship between the identifier assigned to the user terminal by the user terminal manager and the IP address allocated to the user terminal by the IP address manager and to match the identifier and the IP address; and
a transmission manager to connect an internal interface, which is connected to a user terminal, with an external interface, which is connected to an external network, such that the IP based services are connected between the user terminal and the external network.

3. The mobile gateway apparatus of claim 2, wherein the user terminal manager comprises:
an identifier (ID) manager to assign the identifier to the connected user terminal and control mobility of the user terminal based on the identifier; and
a status manager to control a quality of service (QoS) by managing status information including a signal intensity and a connection status that are acquired from the connected user terminal.

4. The mobile gateway apparatus of claim 2, wherein the user terminal manager assigns the identifier to the user terminal by use of an identifier of the internal interface, to which the user terminal is connected, and an access sequence of the user terminal.

5. The mobile gateway apparatus of claim 2, wherein the IP address manager respectively allocates public IP addresses to the multiple external interfaces.

6. The mobile gateway apparatus of claim 2, wherein the IP address manager dynamically allocates a public IP address to a user terminal, which has accessed the mobile gateway apparatus through the internal interface but does not actively assign itself an IP address, through a dynamic host configuration protocol (DHCP).

7. The mobile gateway apparatus of claim 2, wherein the IP address manager allocates a private IP address to a user terminal, which has accessed the mobile gateway apparatus through the internal interface but does not actively assign itself an IP address, through a network address port translation (NAPT).

8. The mobile gateway apparatus of claim 2, wherein the controller further comprises a connection manager to manage a connection setup between the mobile gateway apparatus and the user terminal based on information managed by the user terminal such that an access point connected to the user terminal is prevented from being frequently changing.

9. The mobile gateway apparatus of claim 1, further comprising a mobility manager to guarantee mobility of the mobile gateway apparatus.

10. The mobile gateway apparatus of claim 9, wherein the mobility manager guarantees seamless IP mobility by selecting an external interface having a most suitable connection status at a predetermined time from the multiple external interfaces connected to the external networks to establish an IP communication channel through the selected external interface.

11. The mobile gateway apparatus of claim 1, further comprising an information exchanger to exchange information with respect to another mobile gateway apparatus.

12. The mobile gateway apparatus of claim 11, wherein, if the user terminal migrates into a communication area of the another mobile gateway apparatus, the information exchanger transmits information for succession of IP based service to the another mobile gateway apparatus.

13. The mobile gateway apparatus of claim 12, wherein the information for succession of IP based service includes identifier (ID) information managed by the user terminal manager and IP address allocation information managed by the IP address manager.

14. The mobile gateway apparatus of claim 1, further comprising an authorization agent to authorize a user terminal to use a service provided by the mobile gateway apparatus.

15. The mobile gateway apparatus of claim 1, further comprising a non-IP terminal supporter to support access of a non-IP user terminal which does not support an IP communication standard.

16. The mobile gateway apparatus of claim 15, wherein the non-IP terminal supporter allows the non-IP user terminal to use an IP based service by use of the IP address allocated to the mobile gateway apparatus as an IP address for the IP based service, and distinctively maintains a communication channel between the mobile gateway apparatus and the non-IP user terminal on a lower layer interface than an IP layer by use of an identifier which is allocated to the non-IP user terminal.

17. The mobile gateway apparatus of claim 1, further comprising a routing processor to support a routing function and an adhoc function in a manner that the mobile gateway apparatus is connected to another mobile gateway apparatus through the external interface and thus the mobile gateway apparatus serves as a relay node for routing packets.

18. A method of connecting IP based services through a mobile gateway apparatus, the method comprising:
establishing a communication channel for the IP based services by selecting an external interface having a suitable connection status from multiple external interfaces;
when a user terminal enters a communication area of the mobile gateway apparatus, at the mobile gateway apparatus, authorizing the user terminal to use the mobile gateway apparatus; and
connecting services, wherein, if the user terminal is authorized to use the mobile gateway apparatus, the mobile gateway apparatus allocates an IP address to the authorized user terminal such that the user terminal uses the IP based service.

19. The method of claim 18, further comprising managing a mobility during the connecting of the IP based services, wherein, the mobile gateway apparatus continuously searches for an external interface having a most suitable connection status from the multiple external interfaces connected to networks, thereby establishing an IP communication channel based on the most suitable external interface such that seamless IP mobility is ensured.

20. The method of claim 18, further comprising, if the user terminal migrates into a communication area of another mobile gateway apparatus during the connecting of the IP based services, performing a service succession by transmitting information for succession of the IP based services from the mobile gateway apparatus to the another mobile gateway apparatus to maintain the IP based services.
